(19) United States
(12) Patent Application Publication
(10) Pub. No.: US 2006/0187764 A1
(43) Pub. Date: Aug. 24, 2006

(54) Electronic timepiece

(76) Inventor: Tamotsu Ono, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/353,615

(22) Filed: Feb. 14, 2006

(30) Foreign Application Priority Data
Feb. 21, 2005 (JP) 2005-043298

(51) Int. Cl. G04C 3/00; G04B 1/00

(52) U.S. Cl. 368/204

(57) ABSTRACT

To provide an electronic timepiece having a power source terminal in which a spring is difficult to be fatigued and which is easy to fabricate and integrate. In an electronic timepiece of an indicator type, a circuit block and an anode can of a button battery are arranged to be respectively disposed on a top side and a bottom side of a movement. An hour wheel holder of a conductive elastic material is formed with a spring portion for a power source terminal and a spring portion for a circuit connection terminal. When the hour wheel holder constituting a back integrated part is integrated to the movement, the spring portion for the power source terminal is elastically brought into contact with the anode can 5a of the button battery, the spring portion for the circuit connection terminal is elastically brought into contact with a circuit connection terminal pattern of the circuit block, thereby, the button battery and the circuit block are conducted.

### BACKGROUND OF THE INVENTION

1. Field of the Invention

The present invention relates to a power source terminal structure of an indicator type electronic timepiece constituting a power source thereof by a button battery.

2. Description of the Prior Art

In a general indicator type electronic timepiece, a train wheel for reducing rotation of a rotor in speed to transmit to a second hand, a minute hand and an hour hand is constituted by including a fifth wheel & pinion, a fourth wheel & pinion, a third wheel & pinion, a center wheel & pinion, a minute wheel, and an hour wheel. The second hand is connected to a support shaft front end of the fourth wheel & pinion, the minute hand is connected to a support shaft front end of the center wheel & pinion, and the hour hand is connected to a support shaft front end of the hour hand, respectively.

Rotation of the rotor is transmitted to the fourth wheel & pinion via the fifth wheel & pinion to move the second hand. The center wheel & pinion is rotatably connected around a support shaft of the fourth wheel & pinion, and rotation of the fourth wheel & pinion is transmitted to the center wheel & pinion via the third wheel & pinion to move the minute hand. Further, the hour wheel is rotatably connected around a support shaft of the center wheel & pinion via a center pipe, and rotation of the center wheel & pinion is transmitted to the hour wheel via the minute wheel to move the hour hand.

A drive portion, a control portion, the train wheel and the like are integrated to a top side of the timepiece and therefore, these are referred to as top integrated parts. On the other hand, a calendar portion, for example, a date feed portion, a date indicator, a date corrector portion, a day feed portion, a day indicator, a day corrector portion and the like are parts integrated to an opposed side via a main plate and these are referred to as back integrated parts.

A top side of the main plate is integrated with top integrated parts of a train wheel bridge, a battery connection (+), a battery connection (−), a circuit block, IC, a winding stem, a coil block, a battery and the like. On the other hand, a bottom side of the main plate is integrated with back integrated parts of the date indicator and a date indicator maintaining plate, a dial, an hour wheel holder and the like. The hour wheel holder is a part rotatably integrated to a side of glass of the main plate and interposed between the hour wheel and the dial, and is a slender conductive plate member having an elasticity of stainless steel, a copper material or the like.

In an electronic timepiece constituting a power source by a button battery, as disclosed in, for example, JP-UM-A-6-64191, a battery connection (−) is a slender conductive plate member having an elasticity in which one end thereof is connected to a pattern for a power source provided at a bottom face of a circuit block, and other end thereof is elastically brought into contact with an anode of a battery at a recess portion of a main plate. The one end of the battery connection (−) is a fixed end, and the other end of the battery connection (−) is a free end having an elasticity.

That is, the battery connection (−) of the background art is the slender conductive plate member constituting a top integrated part and extended from the fixed end to the free end. Further in details, the battery connection (−) of the background art is a slender conductive elastic member of a Z letter shape having a shape of being extended horizontally from the fixed end to an opening end of the recess portion, extended vertically from the opening end along a wall face of the recess portion, and extended horizontally along a center of the recess portion from a portion reaching a bottom face thereof.

The battery connection (−) of the background art is formed by the slender conductive plate member having an elasticity and a Z letter shape because whereas the circuit block is disposed on a top side of a movement from a restriction on a sectional layout of the movement, an anode can of the button battery is disposed on a bottom side of the movement, and the battery connection (−) for electrically connecting the circuit block and the anode can of the button battery is integrated from the top side.

However, the slender battery connection (−) having the elasticity and the Z letter-shape is apart fabricated by bending in two stages the slender conductive plate member having the elasticity and therefore, there poses a problem that the spring is easy to be fatigued. Further, also in fabricating the part, a development shape is enlarged and therefore, there poses a problem that a waste is produced which is contradictory to a reduction in cost.

It is a problem of the invention to be resolved to provide an electronic timepiece in which a circuit block and one electrode of a button battery are respectively disposed on a top side and a bottom side of a movement, the electronic timepiece including a power source terminal in which a spring is difficult to be fatigued and fabrication and integration thereof is facilitated and to provide an electronic timepiece having the power source terminal.

### SUMMARY OF THE INVENTION

In order to resolve the above-described problem, there is provided an electronic timepiece in which a circuit block and one electrode of a button battery are arranged to be respectively disposed on a top side and a bottom side of a movement, wherein a power source terminal for electrically connecting the circuit block and the one electrode of the button battery is formed by an elastic conductive member having two pieces of spring portions each having one portion of a fold-to-bend portion, and the power source terminal is made to constitute a back integrated part.

### BRIEF DESCRIPTION OF THE SEVERAL VIEWS OF THE DRAWINGS

A preferred form of the present invention is illustrated in the accompanying drawings in which:

FIG. 1 is a plane view viewed from a bottom side of an electronic timepiece of an indicator type according to Embodiment 1 of the invention;

FIG. 2 is a sectional view of the electronic timepiece at a portion including a spring portion for a power source terminal according to Embodiment 1 of the invention; and

FIG. 3 is sectional view of the electronic timepiece at a portion including a spring portion for a circuit connection terminal according to Embodiment 1 of the invention.

### DETAILED DESCRIPTION OF THE PREFERRED EMBODIMENTS

The invention is applied to an electronic timepiece of an indicator type in which a circuit block and one electrode of a button battery are respectively disposed on a top side and a bottom side of a movement, characterized in that an hour wheel holder is formed with a spring portion for a power source terminal elastically brought into contact with an anode can of the button battery and a spring portion for a circuit connection terminal elastically brought into contact with a circuit connection terminal of the circuit block, and the hour wheel holder is made to serve also as a power source terminal.

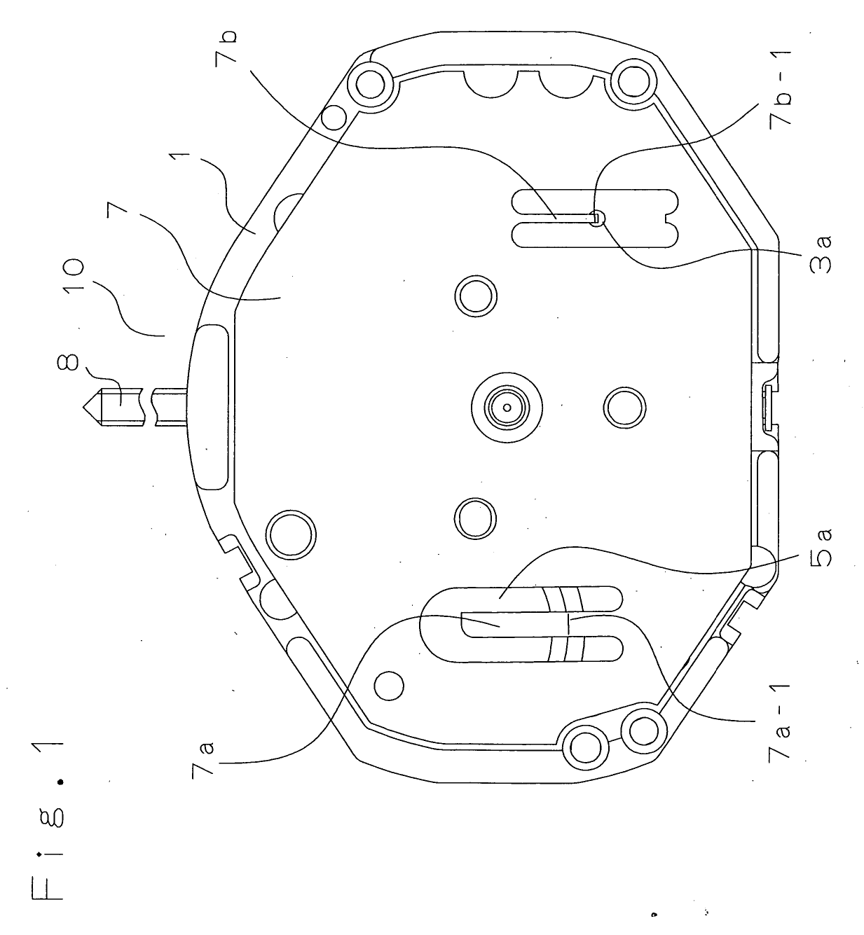

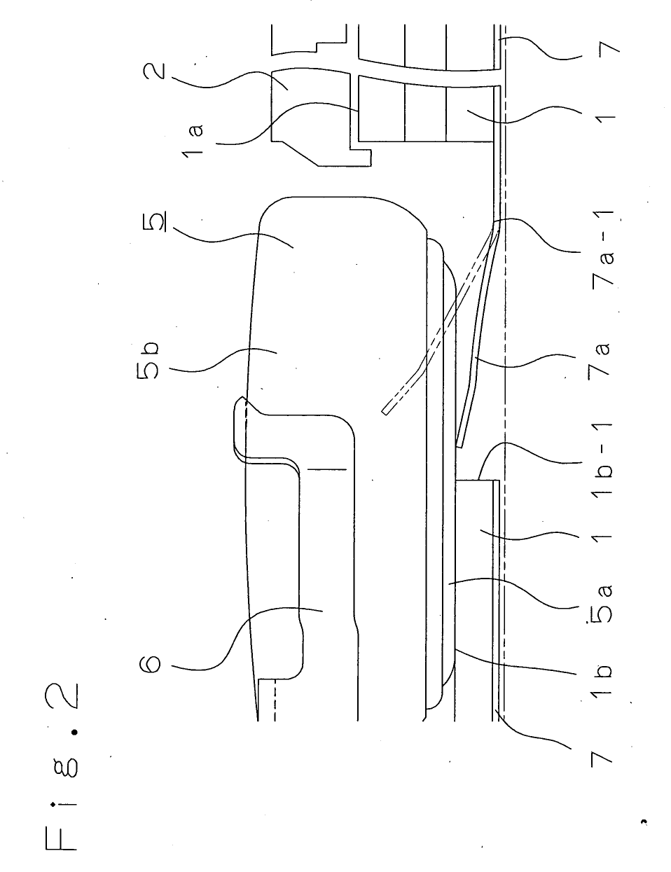

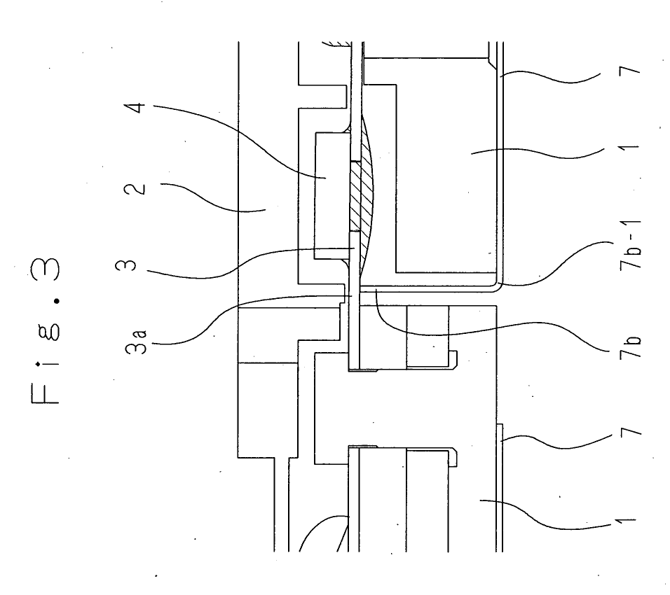

As shown by a plane view of FIG. 1 and partial sectional views of FIG. 2 and FIG. 3, an indicator type analog electronic timepiece according to an embodiment of the invention is an electronic timepiece of an indicator type in which a circuit block 3 and an anode can 5a of a button battery 5 are arranged to be respectively disposed on a top side and a bottom side of a movement 10, characterized in that an hour wheel holder 7 is formed with a spring portion 7a for a power source terminal elastically brought into contact with the anode can 5a of the button battery 5 and a spring portion 7b for a circuit connection terminal elastically brought into contact with a circuit connection terminal pattern 3a of the circuit clock 3 and the hour wheel holder 7 is made to serve also as the power source terminal.

That is, the indicator type analog electronic timepiece according to the embodiment of the invention is provided with the movement 10 a train wheel of which is supported by a main plate 1 and a train wheel bridge 2. A circuit block attaching face 1a of the main plate 1 is attached with the circuit block 3 by directing the pattern 3a for the power source downward. A battery accommodating recess portion of the main plate 1 is contained with the button battery 5 by disposing the anode can 5a downward. The circuit block attaching face 1a is a plane projected to a side of the train wheel bridge 2 and therefore, the circuit block attaching face 1a is disposed at a position higher than a bottom plate 1b of the battery accommodating recess portion by about a half of a thickness of the button battery 3.

The hour wheel holder 7 constituting the back integrated part is arranged to cover a bottom side of the movement 10. The hour wheel holder 7 is a part rotatably integrated to a side of glass of the main plate 1 and interposed between an hour wheel and a dial and is a slender conductive elastic member of stainless steel, a copper material or the like.

In sum, the electronic timepiece according to the embodiment to which the invention is applied is an indicator type analog electronic timepiece in which the circuit block 3 and the anode can 5a of the button battery 5 are arranged to be respectively disposed on the top side and the bottom side of the movement 10.

A power source plus terminal 6 is elastically brought into contact with a cathode 5b of the button battery 5, and the spring portion 7a for the power source terminal functioning as a portion of the battery connection (−) is elastically brought into contact with the anode can 5a of the button battery 5. Further, a front end of the spring portion 7b for the circuit connection terminal functioning as a portion of the battery connection (−) is elastically brought into contact with the pattern 3a for the power source of the circuit block 3 attached to the circuit block attaching face 1a of the main plate 1.

The spring portion 7a for the power source terminal and the spring portion 7b for the circuit connection terminal respectively functioning as portions of the battery connection (−) are formed at the hour wheel holder 7 of a conductive elastic material.

The spring portion 7a for the power source terminal is formed as a slender tongue piece integral with the hour wheel holder 7 at a predetermined portion of the hour wheel holder 7, that is, at a portion thereof in correspondence with an opening 1b-1 formed at the bottom face 1b of the battery accommodating recess portion. The spring portion 7a for the power source terminal constituted by the slender tongue piece is formed with one fold-to-bend portion 7a-1 having an angle of substantially 30 degrees to thereby provide spring performance. Although the spring portion 7a for the power source terminal constituted by the slender tongue piece is also formed with a fold-to-bend portion 7a-2 having an angle of substantially 5 degrees, the fold-to-bend portion 7a-2 is auxiliary.

The spring portion 7b for the circuit connection terminal is formed as a slender tongue piece integral with the hour wheel holder 7 at other predetermined portion of the hour wheel holder 7, that is, at a portion thereof in correspondence with the pattern 3a for the power source of the circuit block 3 attached to the circuit block attaching face 1a at a portion of the hour wheel holder 7. The spring portion 7b for the circuit connection terminal constituted by the slender tongue piece is formed with the one fold-to-bend portion 7a-1 having an angle, substantially 90 degrees to thereby provide spring performance. Further, a width of the spring portion 7b for the circuit connection terminal is made to be narrower than that of the spring portion 7a for the power source terminal, thereby, soft spring performance is realized.

Owing to the above-described constitution, when the hour wheel holder 7 constituting a back integrated part is integrated to the movement 10, the spring portion 7a for the power source terminal of the hour wheel holder 7 is elastically brought into contact with the anode can 5a of the button battery 5, and the spring portion 7b for the circuit connection terminal is elastically brought into contact with the circuit connection terminal pattern 3a of the circuit block 3, thereby, the button battery 5 and the circuit block 3 are conducted by way of the hour wheel holder 7. In other words, the hour wheel holder constituting the back integrated part functions as the power source minus terminal.

The power source minus terminal which serves also as the hour wheel holder 7 constituting the back integrated part is provided with two pieces of the spring portions each having one portion of the fold-to-bend portion and therefore, the problem that the spring of the slender battery connection (−) having the elasticity in the Z letter type of the background art is easy to be fatigued is resolved. Further, in comparison with the slender battery connection (−) having the elasticity of the Z letter type of the background art which is a part fabricated by bending in two stages a slender conductive plate member having an elasticity, the power source minus terminal is easy to be fabricated and can simply be integrated to the back side.

Although a detailed explanation has been given of the power source minus terminal which serves also as the hour wheel holder 7 constituting the back integrated part, the power source minus terminal of the back integrated part constituting the invention can also be formed as a part separate from the hour wheel holder 7. In sum, the power source minus terminal is formed by an elastic conductive member having two pieces of the spring portions each having one portion of the fold-to-bend portion and when the member is made to constitute a part which can be integrated to the backside, the power source minus terminal of the back integrated part constituting the invention can be realized.

The power source terminal is formed by the elastic conducting member having two pieces of the spring portions each having one portion of the fold-to-bend portion, the power source terminal is made to constitute the back integrated part and therefore, integration thereof to the movement becomes much easier than that of the background art. Further, the power source terminal can be fabricated without being processed by a troublesome step of bending in two stages and therefore, the power source terminal is easy to be fabricated. Further, the spring is difficult to be fatigued as in the slender battery connection (−) having the elasticity and the Z letter shape of the background art.

Further, in an electronic timepiece of an indicator type according to the invention characterized in that an hour wheel holder is formed with a spring portion for a power source terminal elastically brought into contact with the one electrode of the button battery and a spring portion for a circuit connection terminal elastically brought into contact with a circuit connection terminal of the circuit block, and the hour wheel holder is made to serve also as the power source terminal, in addition to the above-described effect, a reduction in part cost and fabrication cost can also be realized.

What is claimed is:

1. An electronic timepiece in which a circuit block and one electric pole electrode of a button battery are arranged to be respectively disposed on a top side and a bottom side of a movement comprising;
wherein a power source terminal for electrically connecting the circuit block and the one electrode of the button battery is formed by an elastic conductive member having two pieces of spring portions each having one portion of a fold-to-bend portion, and the power source terminal is made to constitute a back integrated part.

2. An electronic timepiece of an indicator type in which a circuit-block and one electrode of a button battery are arranged to be respectively disposed on a top side and a bottom side of a movement comprising;
wherein an hour wheel holder is formed with a spring portion for a power source terminal elastically brought into contact with the one electrode of the button battery and a spring portion for a circuit connection terminal elastically brought into contact with a circuit connection terminal pattern of the circuit block, and the hour wheel holder is made to serve also as the power source terminal.

3. An electronic timepiece according to claim 1, wherein the one electrode of the button battery is an anode can and the power source terminal is a battery connection (−).

4. An electronic timepiece according to claim 2, wherein the one electrode of the button battery is an anode can and the power source terminal is a battery connection (−).
